(19) United States
(12) Patent Application Publication
(10) Pub. No.: US 2011/0032434 A1
(43) Pub. Date: Feb. 10, 2011

(54) LIGHTING DEVICE, DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/920,667

(22) PCT Filed: Oct. 27, 2008
(86) PCT No.: PCT/JP2008/069438

§ 371 Date: Sep. 2, 2010

(30) Foreign Application Priority Data
Mar. 12, 2008 (JP) 2008-063043

(51) Int. Cl. H04N 5/66; F21S 4/00; H05B 37/02; G02F 1/13357; G02F 1/1335

(52) U.S. Cl. 348/739; 362/249.01; 362/225; 315/294; 362/97.1; 349/61; 348/E05.133

(57) ABSTRACT

A lighting device of the present invention includes a light source 17, a power source 170 configured to supply driving power to the light source 17, and a relay member 150 configured to electrically connect the light source 17 and the power source 170. The light source 17 includes an outer lead 42 for receiving the driving power. The relay member 150 includes a relay body 152 having a void 158 in which the outer lead 42 is placed and the relay body 152 is formed of conductive rubber. The outer lead 42 is placed in the void 158 of the relay body 152 with elastic contact thereof and an inner surface of the void 158.

### TECHNICAL FIELD

The present invention relates to a lighting device, a display device and a television receiver.

### BACKGROUND ART

In a display device using a non-light emitting optical component such as a liquid crystal display device, a backlight device is provided behind a display panel such as a liquid crystal display panel for illuminating the display panel (see Patent Document 1 as an example).

### Patent Document 1: JP-A-2006-351527

### Problem to be Solved by the Invention

The backlight device disclosed in the above Patent Document 1 comprises a receiving container, a first side mold, a printed circuit board and lamps. The first side mold is provided on each side of the receiving container. The printed circuit board is fixed to the first side mold and provided with a plurality of conductive clips and a power supply line assembly for transmitting lamp driving electric power. The lamps are combined with the conductive clips via external electrodes provided on an outer surface of an end portion to generate light upon receiving the lamp driving electric power.

The above-described backlight device has a configuration in which the lamps are combined with and fixed by the clips via the external electrodes. This configuration requires the external electrodes and increases cost. The lamps may be combined with and fixed by the clips with directly holding outer leads of the lamps without using the external electrodes. This may apply excessive stress to the outer leads and damage them. The damage to the outer leads causes leaking of gas from the lamps and poor conductivity, and accordingly the lamps fail to emit light. On the other hand, if the holding force is reduced by using the clips to prevent the damage to the outer leads, poor electrical connection between the outer leads and the clips is caused. In such a case also, the lamps may fail to emit light.

### DISCLOSURE OF THE PRESENT INVENTION

The present invention was made in view of the foregoing circumstances, and an object thereof is to provide a lighting device that contributes to a cost reduction and hardly causes a light emission error due to poor electrical connection. Another object of the present invention is to provide a display device having such a lighting device and a television receiver having such a display device.

### Means for Solving the Problem

To solve the above problem, a lighting device of the present invention includes at least one light source, a power source configured to supply driving power to the light source, and a relay member configured to electrically connect the light source and the power source. The light source includes an outer lead for receiving the driving power supplied by the power source. The relay member includes at least one relay body having a void in which the outer lead is inserted, and the relay body is formed of conductive rubber. The outer lead is placed in the void of the relay body with elastic contact thereof and an inner surface of the void.

According to such a lighting device, the outer lead is just inserted in the void of the relay body without using an external electrode such as a ferrule or the like to easily establish electric connection to the light source. This reduces the number of components and contributes to a cost reduction.

Since the relay body is formed of conductive rubber, in the state that the outer lead is inserted in the void, the elastic deformation of the conductive rubber ensures reliable contact (reliable electrical connection) between the outer lead and the inner surface of the void. The elastic contact reliably ensures the contact between the outer lead and the inner surface of the void even if a small positional gap (relative movement) is generated therebetween. If a dimension error in manufacturing occurs in the relay body (void) and the light source (outer lead), the elasticity compensates for the error to ensure the reliable contact between the outer lead and the inner surface of the void. As a result, highly reliable electric connection is achieved and a backlight device that hardly causes light emission errors due to poor electrical connection can be provided. The relay body formed of rubber makes elastic contact between the outer lead and the inner surface of the void. Accordingly, excessive stress is less likely to be applied to the outer lead and thus the outer lead is less likely to be damaged. A highly reliable lighting device that hardly causes errors such as light emission errors can be provided.

### BRIEF DESCRIPTION OF THE DRAWINGS

FIG. 1 is an exploded perspective view illustrating a general construction of a television receiver;

FIG. 2 is an exploded perspective view illustrating a general construction of a liquid crystal display device (display device);

FIG. 3 is a cross-sectional view of FIG. 2 along the line A-A;

FIG. 4 is a front view illustrating a construction of a main part of the lighting device;

FIG. 5 is a front view illustrating a construction of the main part illustrated in FIG. 4 without cold cathode tubes;

FIG. 6 is a rear view illustrating a construction of a main part of the lighting device;

FIG. 7 is a perspective view illustrating a construction of a relay member;

FIG. 8 is an explanatory view illustrating a circuit configuration for power supply;

FIG. 9 is a perspective view illustrating a construction of the cold cathode tube;

FIG. 10 is a cross-sectional view illustrating a construction of the cold cathode tube;

FIG. 11 is a perspective view typically illustrating a construction for power supply;

FIG. 12 is a perspective view illustrating a construction of a relay body;

FIG. 13 is an explanatory view illustrating a state in that the cold cathode tube is attached to the relay body;

FIG. 14 is an explanatory view illustrating a construction of a state in that the cold cathode tube is attached to the relay body;

FIG. 15 is a plan view illustrating a modification of the relay body;

FIG. 16 is a perspective view illustrating a construction of a relay member according to a first modification;

FIG. 17 is an explanatory view illustrating a circuit configuration of the relay member;

FIG. 18 is an explanatory view typically illustrating a construction for power supply;

FIG. 19 is a perspective view illustrating a construction of a relay body applied to the relay member of the first modification;

FIG. 20 is an explanatory view illustrating a modification of a power supply mechanism;

FIG. 21 is an explanatory view illustrating another modification of a power supply mechanism;

FIG. 22 is an explanatory view illustrating one example of a mechanism that provides insulation between a chassis and the relay member;

FIG. 23 is an explanatory view illustrating one example of a mechanism that provides insulation between the chassis and the relay member;

FIG. 24 is an explanatory view illustrating another modification of the power supply mechanism;

FIG. 25 is an explanatory view illustrating an arrangement of power supply board provided on a rear surface of the chassis;

FIG. 26 is an explanatory view illustrating a modification of an arrangement of the power supply board;

FIG. 27 is an explanatory view illustrating a modification of an arrangement of the power supply board;

FIG. 28 is an explanatory view illustrating a modification of an arrangement of the power supply board;

FIG. 29 is a typical cross-sectional view illustrating a modification of the power supply mechanism;

FIG. 30 is a typical cross-sectional view illustrating a modification of the power supply mechanism;

FIG. 31 is a typical plan view illustrating the power supply mechanism in FIG. 30;

FIG. 32 is a typical bottom view illustrating the power supply mechanism in FIG. 30;

FIG. 33 is a typical cross-sectional view illustrating a modification of the power supply mechanism;

FIG. 34 is a typical plan view illustrating the power supply mechanism in FIG. 33; and

FIG. 35 is a typical bottom view illustrating the power supply mechanism in FIG. 33.

### BEST MODE FOR CARRYING OUT THE INVENTION

An embodiment of the present invention will be explained with reference to drawings.

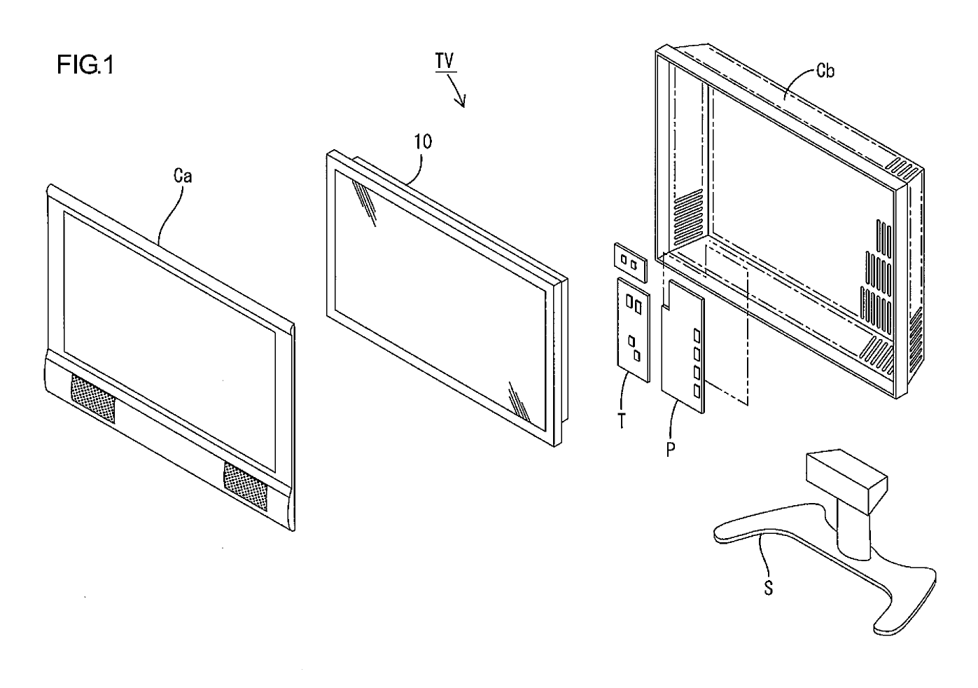

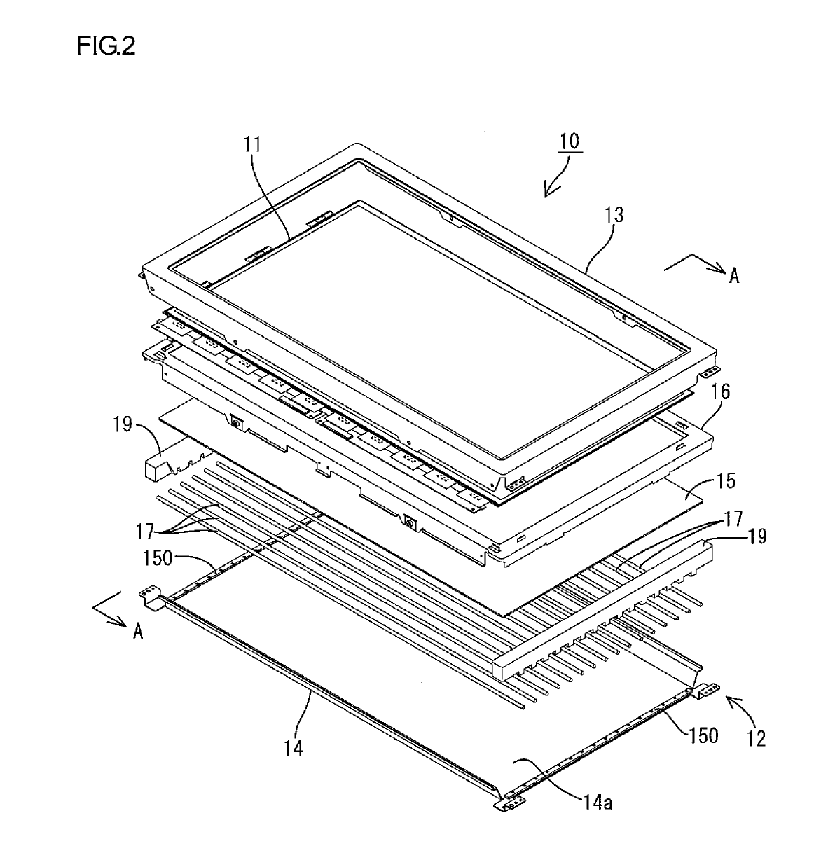

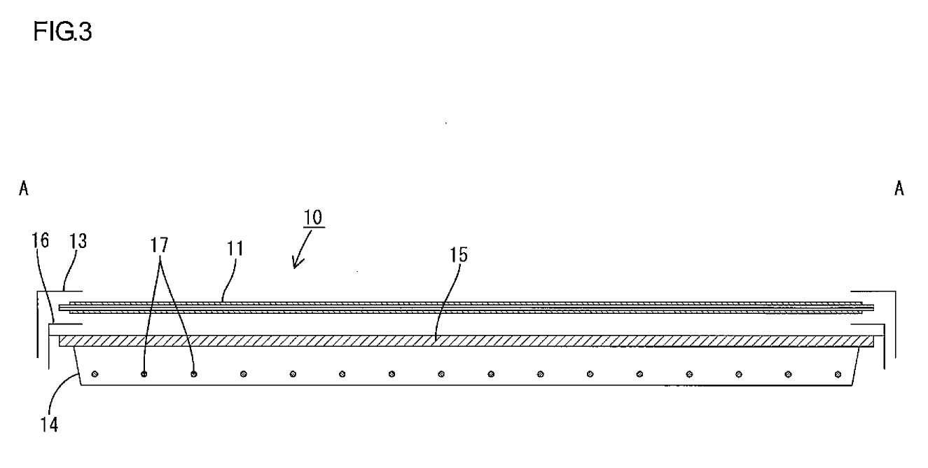

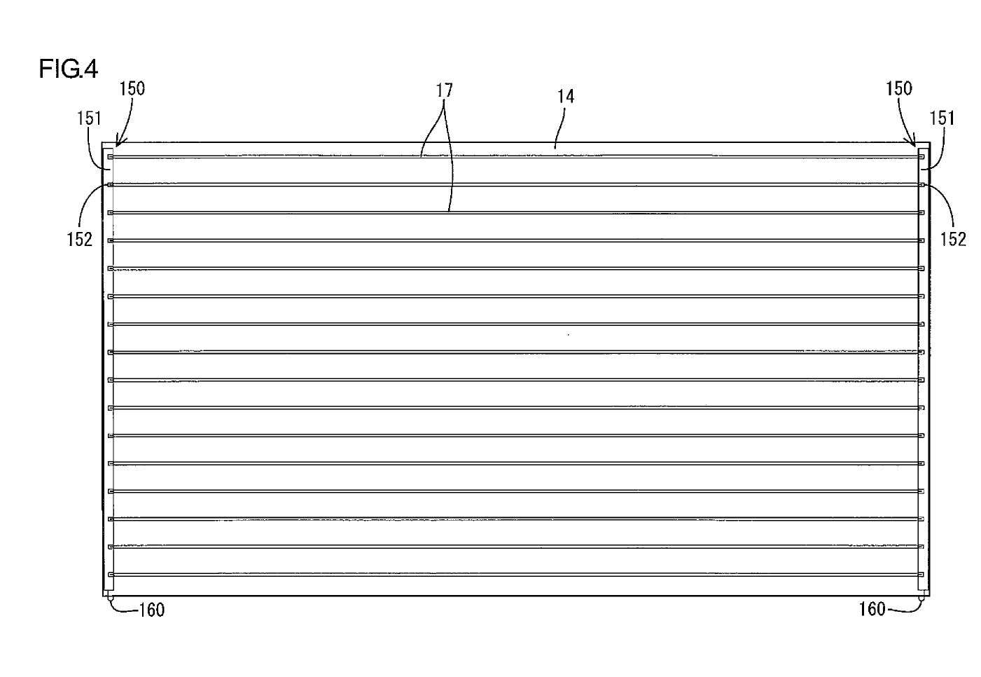

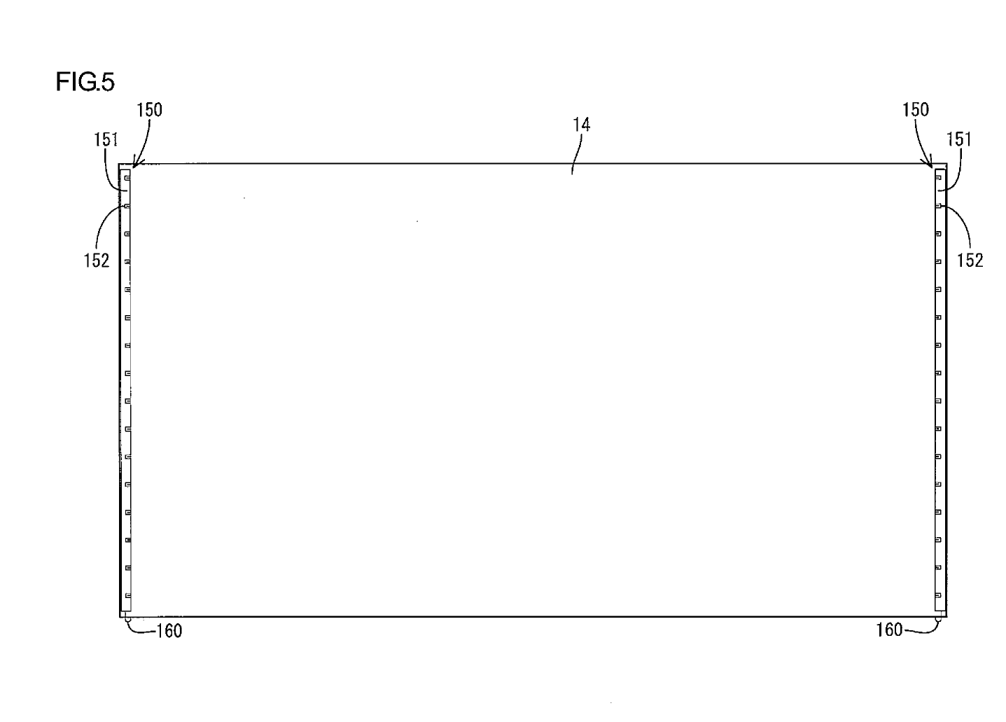

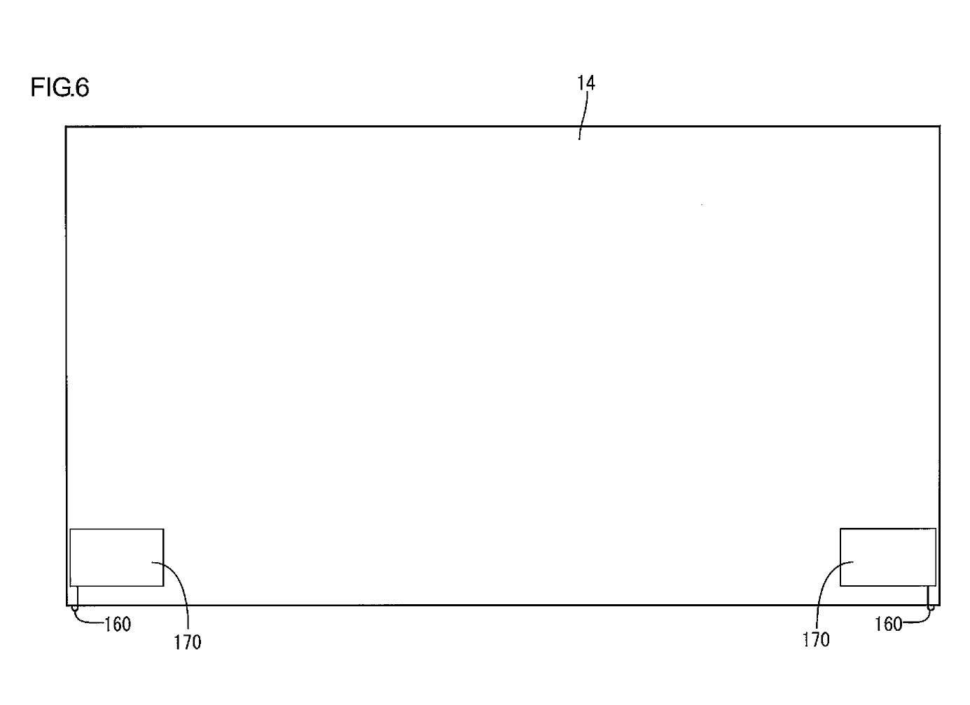

FIG. 1 is an exploded perspective view illustrating a general construction of a television receiver. FIG. 2 is an exploded perspective view illustrating a general construction of a liquid crystal display device (display device) 10 included in the television receiver. FIG. 3 is a cross-sectional view of FIG. 2 along the line A-A. FIG. 4 is a front view illustrating a construction of a main part of a backlight device included in the liquid crystal display device 10. FIG. 5 is a front view illustrating a construction of the main part of the backlight device. FIG. 6 is a rear view illustrating a construction of the main part of the backlight device.

As illustrated in FIG. 1, the television receiver TV of the present embodiment includes a liquid crystal display device (display device) 10, front and rear cabinets Ca, Cb that house the liquid crystal display device 10 therebetween, a power source P, a tuner T and a stand S. An overall view of the liquid crystal display device 10 is a landscape rectangular. As illustrated in FIG. 2, it includes a liquid crystal panel 11, which is a display panel having a rectangular plan view, and a backlight device (lighting device for a display device) 12, which is an external light source. They are integrally held by a bezel 13 and the like.

The liquid crystal panel 11 has a known configuration such that liquid crystal (a liquid crystal layer) that changes its optical characteristics according to applied voltages is sealed between a transparent TFT substrate and a transparent CF substrate. A number of source lines and gate lines are formed on an inner surface of the TFT substrate. The source lines extend in a longitudinal direction and the gate lines extend a transverse direction so as to form a grid pattern. Color filters including red (R), green (G) and blue (B) are provided on the CF substrate. Polarizing plates are attached to surfaces of those substrates on sides opposite from the liquid crystal side.

The backlight device 12 is a so-called direct backlight device in which a light source is arranged closely below the liquid crystal panel 11. The backlight device 12 includes a chassis 14, a reflective sheet 14a, an optical member 15, a frame 16, cold cathode tubes (light sources (linear light sources, tubular light sources, discharge tubes)) 17 and lamp holders 19. The chassis 14 has an opening on the front (light output side). The reflective sheet 14a is placed inside the chassis 14. The optical member 15 is arranged around the opening of the chassis 14. The frame 16 holds the optical member 15. The cold cathode tubes 17 are installed in the chassis 14. The lamp holders 19 shield ends of the cold cathode tubes 17 from light and have light reflectivity.

The optical member 15 has a function that converts linear light emitted from each cold cathode tube 17, which is a linear light source, to planar light, and directs the planar light toward an effective display area of the liquid crystal panel 11 (directivity).

The chassis 14 is formed of metal and in a substantially box-shape having a rectangular plan view and an opening on the front (light output side). The reflective sheet 14a is made of synthetic resin and a white material having good reflectivity. It is disposed in the chassis 14 so as to cover an entire inner surface of the chassis 14. The reflective sheet 14a directs most light emitted from each cold cathode tube 17 toward an opening side of the chassis 14.

As illustrated in FIGS. 4 and 5, a relay member 150 for relaying (conducting) driving power supplied from the power supply board (power source) 170 (see FIG. 6) to the cold cathode tubes 17 are disposed on an inner surface of the chassis 14. Each of the relay members 150 includes a base 151 that is made of an insulated substrate and relay bodies 152 provided for the respective cold cathode tubes 17. In the present embodiment, the relay member 150 is mounted to each side of the chassis 14 so as to overlap with each end of the cold cathode tube 17. As illustrated in FIG. 6, power supply boards 170 including inverter circuits for supplying driving power to the cold cathode tubes 17 are disposed on the rear surface of the chassis 14.

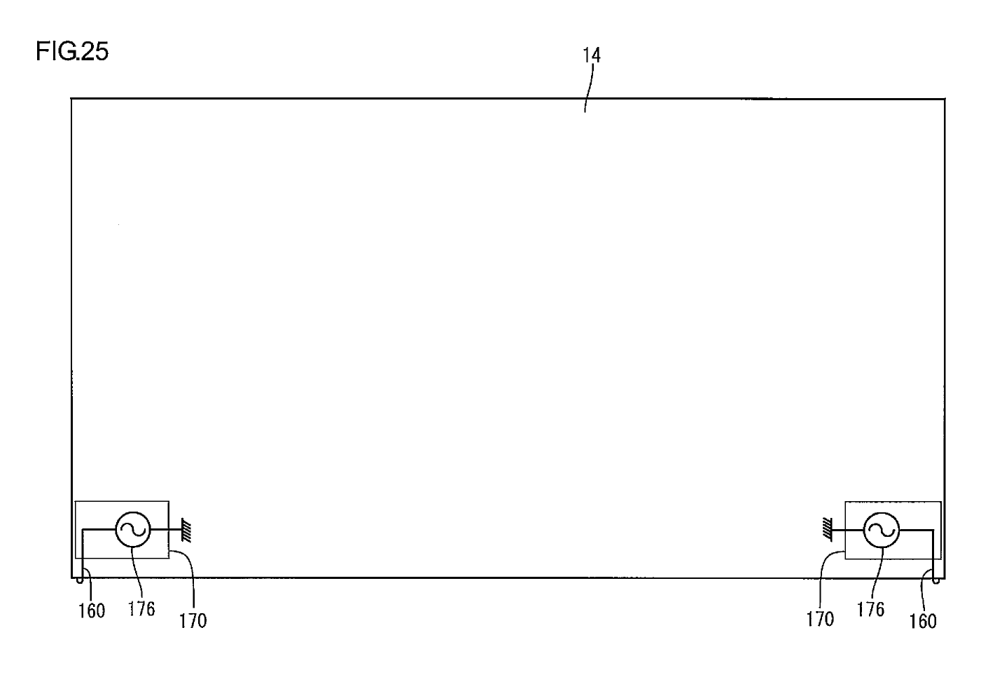

Configuration and operation for supplying the driving power to the cold cathode tubes 17 will be explained. A two-side driving system is used here. As illustrated in FIG. 25, power sources 176 are included in the power supply boards 170 arranged on either side and supply power to the cold cathode tubes 17 via their both ends.

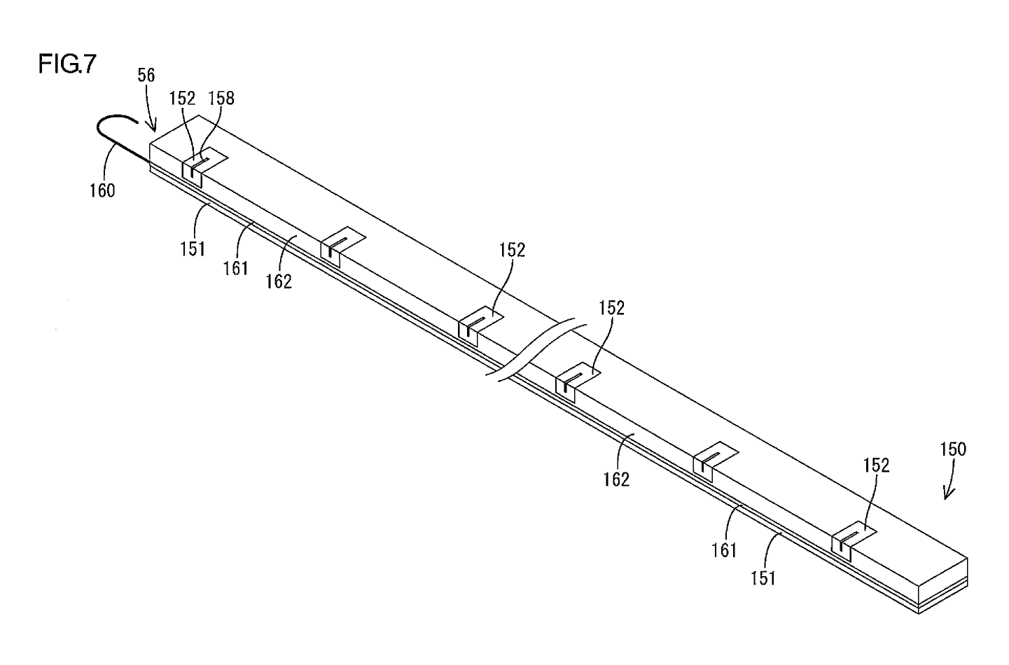

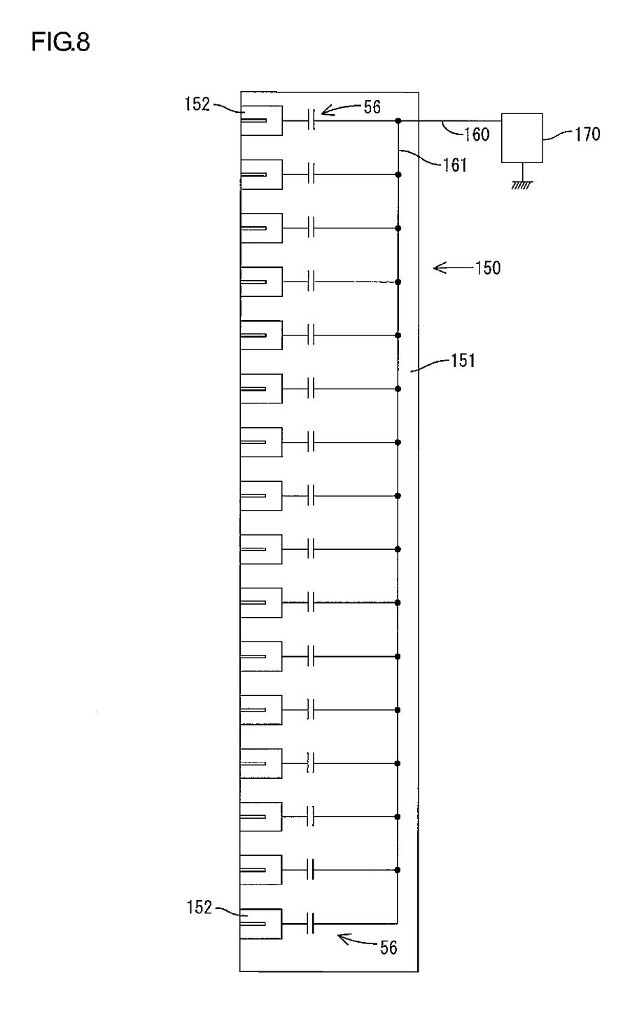

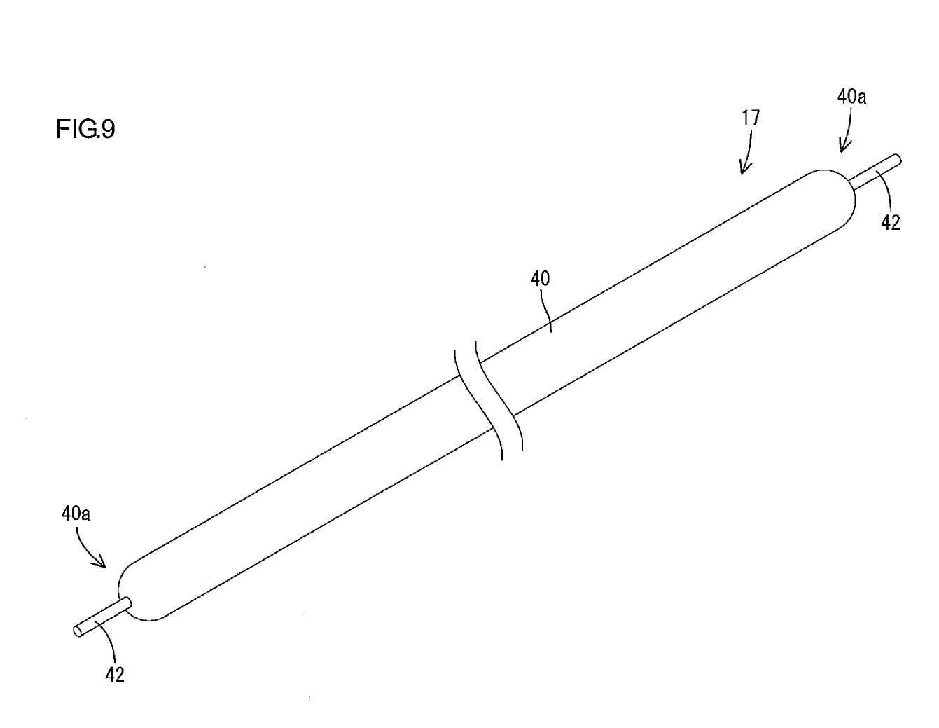

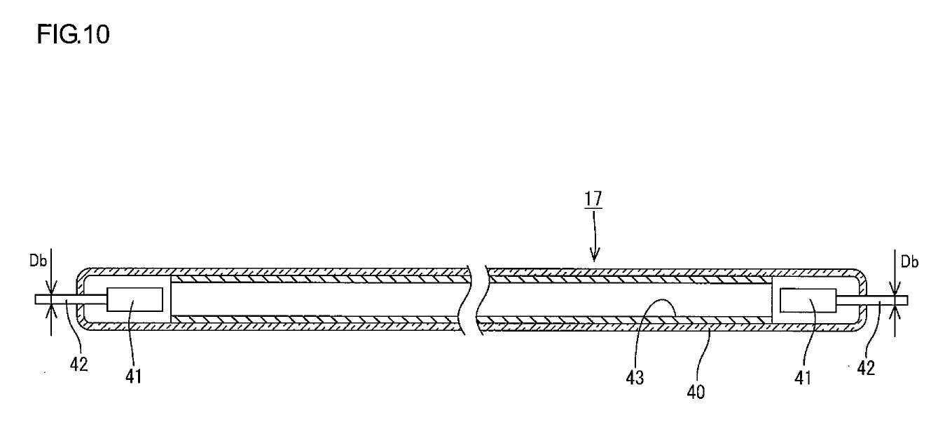

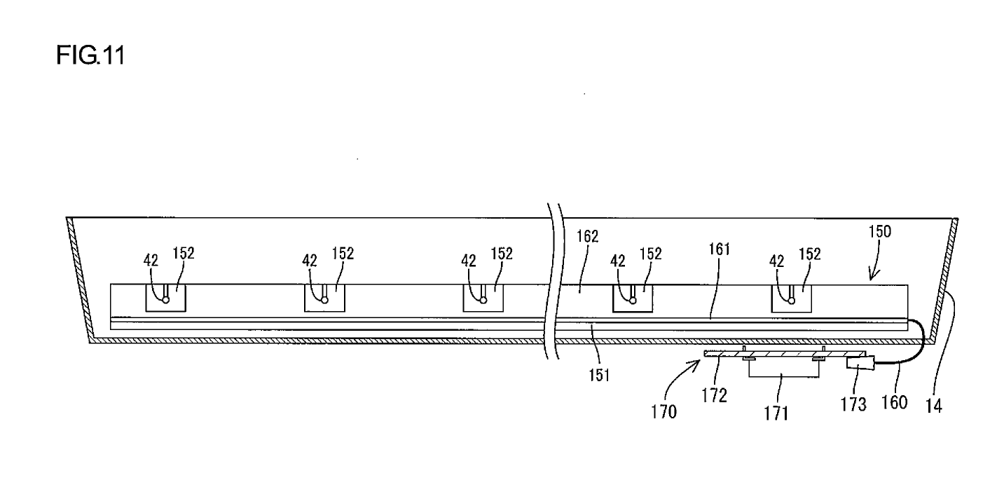

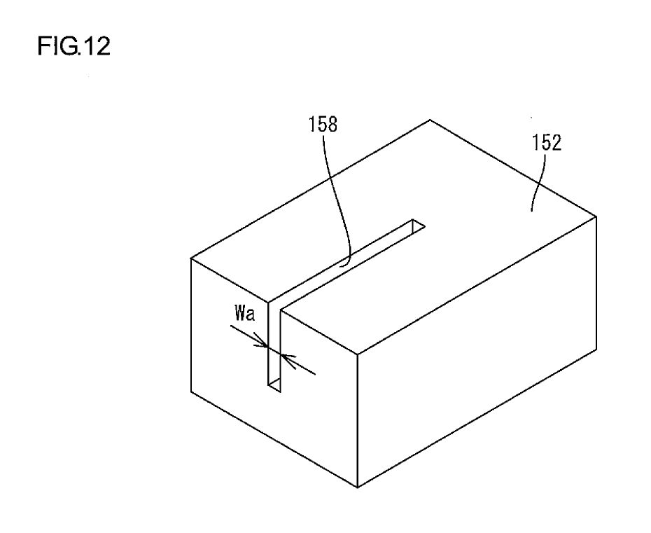

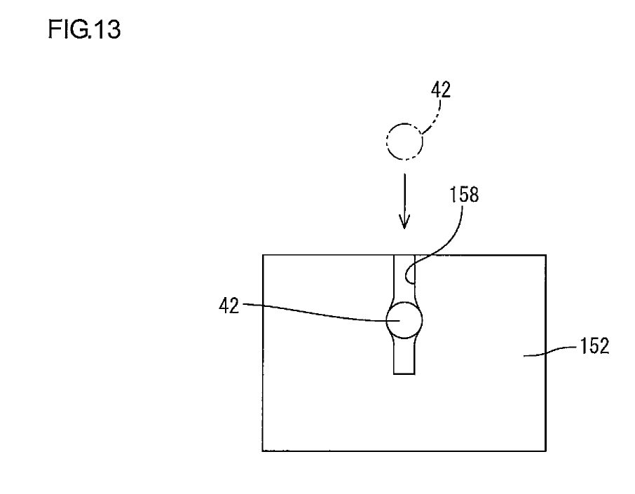

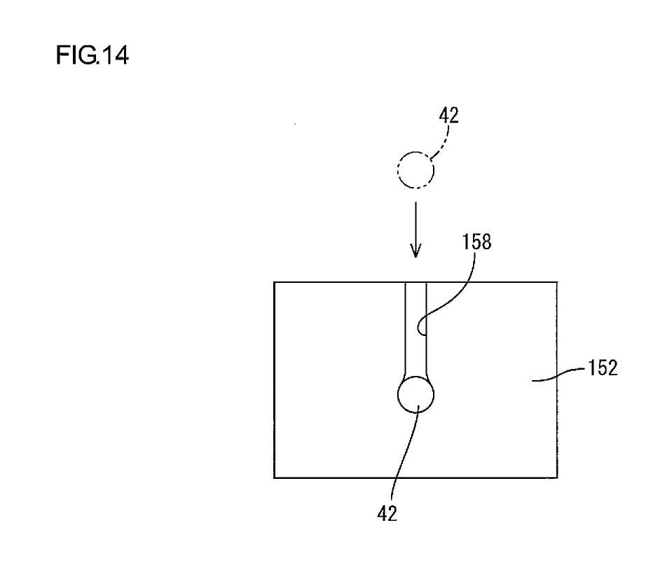

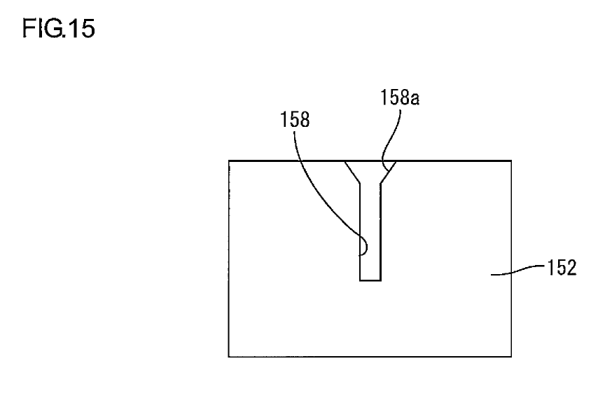

FIG. 7 is a perspective view illustrating a general construction of the relay member 150 including the relay bodies 152. FIG. 8 is an explanatory view illustrating a circuit configuration related to power supply. FIG. 9 is a perspective view illustrating a construction of the cold cathode tube 17. FIG. 10 is a cross-sectional view illustrating a construction of the cold cathode tube 17. FIG. 11 is an explanatory view illustrating a construction for power supply. FIG. 12 is a perspective view illustrating a construction of a relay body 152. FIG. 13 is an explanatory view illustrating a state in that the cold cathode tube 17 is being attached to (inserted in) the relay body 152. FIG. 14 is an explanatory view illustrating a construction of a state in that the cold cathode tube 17 is attached to (inserted in) the relay body 152. FIG. 15 is a plan view illustrating a modification of the relay body 152.

[Cold Cathode Tubes 17]

First, the construction of each cold cathode tube 17 will be explained.

The cold cathode tube 17 is formed in an elongated tubular shape and a plurality of the cold cathode tubes 17 are arranged in parallel to each other in the chassis 14 such that a longitudinal direction (axes) thereof matches the long-side direction of the chassis 14 (see FIGS. 2 to 4). As illustrated in FIGS. 9 and 10, the cold cathode tube 17 includes an elongated glass tube 40 two ends of which are closed, electrodes 41 enclosed inside the both ends of the glass tube 40, and outer leads 42 extending from the electrodes 41 to the outside of the glass tube 40, respectively.

Noble gas and mercury are enclosed in the glass tube 40 and the inner surface of the glass tube 40 is coated with a fluorescent material 43. Portions at two ends of each cold cathode tube 17 provided with the electrodes 41 correspond to non-light-emitting portions and a center portion of each cold cathode tube 17 (that is coated with the fluorescent material 43) corresponds to a light-emitting portion. Each outer lead 42 is attached to the corresponding relay body 152 of the relay member 150 such that the cold cathode tube 17 is fixed to the chassis 14. The relay member 150 to which the ends of the cold cathode tubes 17 are attached is covered with a lamp holder 19.

The outer leads 42 are terminals for making electrical connection with external components. Each outer lead 42 is a linear outer lead having a longitudinal overall shape and a circular cross section. The outer lead 42 is made of metal (e.g., nickel or cobalt containing metal) and formed in a longitudinal shape having a circular cross section with the same center as the glass tube 40. An outer diameter Db of the outer lead 42 is substantially 0.5 mm to 1 mm and greater than an opening width Wa of a void 158 of the relay body 152 (see FIG. 12).

[Relay Member 150]

Next, a configuration of the relay member 150 will be explained.

The relay member 150 fixes the cold cathode tubes 17 to the chassis 14 and also relays power supply from the power supply board (power source) 170 to the cold cathode tubes 17. The relay member 150 of the present embodiment is provided along each side end of the chassis 14 (see FIGS. 4 and 5). As illustrated in FIGS. 7, 8 and 11, the relay member 150 includes a base 151 formed of an elongated insulated substrate, a conductive layer (conductive portion) 161 disposed on the base 151, a dielectric layer (dielectric portion) 162 formed of a thin layer made of a dielectric material and provided on the conductive portion 161, and the relay body 152 that is embedded in the dielectric layer 162 such that a surface of the relay body 152 is exposed from the surface of the relay member 150.

The base 151 is formed of a plate made of an insulating material such as glass-epoxy resin and attached and fixed to the chassis 14. A material used for the base 151 is not limited to glass-epoxy resin and any insulating materials such as paper phenol can be used for the base 151.

The conductive layer 161 is made of metal such as copper foil that is provided on the base 151 with patterning. The conductive layer 161 is connected to the power supply board 170 via a harness (power supply path) 160. The conductive film 161 is formed as a common line to a plurality of relay bodies 152. One conductive layer 161 is formed on the base 151 to supply driving power from the conductive layer 161 to each relay body 152 via the dielectric layer 162.

The dielectric layer 162 is formed of a dielectric material such as metal oxide, metal nitride or resin. The dielectric layer 162 is disposed between the conductive layer 161 and the relay bodies 152 both of which are conductive and it forms a capacitor (balancing component) 56. The balancing component, that is, the capacitor 56 controls a current balance of driving power supplied to each relay body 152 or each cold cathode tube 17 to make the current supplied to each cold cathode tube 17 constant.

As illustrated in FIG. 8, each capacitor 56 is connected to the power supply board 170 in parallel and each capacitor 56 is connected to the conductive layer (common line) 161 in parallel here. Electrical connection with the power supply board 170 is collectively made through the harness 160 derived from the conductive layer 161. The capacitors 56 and the power supply board 170 are connected via lines that are less than the cold cathode tubes 17, specifically, connected via one harness 160. The harness 160 is routed from an edge of the base 151 disposed on the inner surface (inner surface side) of the chassis 14 to the power supply board 170 disposed on the outer surface (outer surface side) of the chassis 14, for example, as illustrated in FIG. 11.

The relay bodies 152 are provided for the respective cold cathode tubes 17. The relay body 152 grips or holds the outer lead 42 of each cold cathode tube 17 to position and fix the cold cathode tube 17 (attach the cold cathode tube 17 to the chassis 14). The relay body 152 relays and supplies driving power to each cold cathode tube 17. According to the present embodiment, the relay body 152 is formed of conductive rubber to have conductivity and is elastically deformable. Specifically, as illustrated in FIG. 12, the relay body 152 is formed of conductive rubber formed in a cubic shape or a rectangular parallelpiped and has the void 158 of a slit on its surface (upper surface) in which the outer lead 42 of the cold cathode tube 17 can be inserted. As illustrated in FIGS. 7 and 11, the cubic relay body 152 is embedded in the dielectric layer 162 such that the void 158 visible from the surface of the relay member 150. The outer lead 42 of the cold cathode tube 17 is inserted in the void (slit) 158 and the cold cathode tube 17 is fixed at a defined position.

In the present embodiment, the relay body 152 is made of conductive rubber, and an opening width Wa of the void 158 is for example approximately 0.1 mm to 0.5 mm and is smaller than the outer diameter Db of the outer lead 42 as described above. As illustrated in FIG. 13, when inserting the outer lead 42 in the void 158, the relay body 152 is elastically deformed and the void 158 becomes larger. As illustrated in FIG. 14, when the outer lead 42 is completely inserted in the void 158 of the relay body 152 (insertion is completed), it is placed with elastic contact thereof and an inner surface of the void 158. The outer lead 42 is fixed tightly by elastic restoring force of the relay body 152 and it is not dropped off from the void 158. Examples of the relay body 152 made of conductive rubber include one made by kneading carbon into a rubber material such as silicone rubber or one made by kneading particles of metal such as silver, copper or gold into a rubber material. As illustrated in FIG. 15, the opening portion of the void 158 maybe enlarged to form an insertion guide 158a to guide insertion of the outer lead 42 and make the insertion easier.

[Power Supply Board 170]

As illustrate in FIG. 11, the power supply board 170 includes a circuit board 172 having circuits on its rear surface (on the opposite side from the chassis 14), electronic components 171 mounted on the circuit board 172, and an on-board connector 173 mounted on the circuit board 172. The electronic components 171 include, for example, a transformer, and the circuit board 172 is configured as an inverter circuit board that generates a high frequency voltage. The on-board connector 173 is mounted on an edge area of the circuit board 172 and connected to the line (harness) 160. The power supply board 170 is assembled and fixed to the chassis 14 with screws and the like.

According to the television receiver TV of the present embodiment, the liquid crystal display device 10 includes the backlight device (lighting device) 12 having the configuration of the present invention. Therefore, it provides the following operation effects.

The outer lead 42 is just inserted in the void 158 of the relay body 152 without attaching an external electrode such as a ferrule to the cold cathode tube 17 to easily establish electric connection or power supply to the cold cathode tubes 17. Since the external electrode is not provided, the number of components is reduced and a cost reduction is achieved.

The relay body 152 is formed of conductive rubber, and in the state that the outer lead 42 is inserted in the void 158, the elastic deformation of the conductive rubber ensures reliable contact and reliable electrical connection between the outer lead 42 and the inner surface of the void 158. Therefore, the elastic contact reliably ensures the contact between the outer lead 42 and the inner surface of the void 158 even if a small positional gap (relative movement) is generated therebetween. If a dimension error in manufacturing occurs in the relay body 152 (void 158) and the cold cathode tube 17 (outer lead 42), the elasticity compensates for the error to ensure the reliable contact between the outer lead 42 and the inner surface of the void 158. As a result, the relay member 150 provides reliable electrical connection and the backlight device 12 hardly causes light emission errors due to poor electrical connections. Because the relay body 152 is formed of rubber, the outer lead 42 and the inner surface of the void 158 have elastic contact. Accordingly, excessive stress is less likely to be applied to the outer lead 42 and the outer lead 42 is less likely to be damaged. This hardly causes errors such as light emission errors.

The relay body 152 is configured such that the void 158 has the width Wa smaller than the outer diameter Db of the outer lead 42 in the free state without the outer lead 42 being placed in the void 158. Therefore, when inserting the outer lead 42 in the void 158, the void 158 becomes larger due to its elastic deformation, and the inner surface of the void 158 is elastically in contact with the outer lead 42 reliably due to its elastic restoring force. This ensures the above-described reliable electric conductivity.

The present invention is not limited to the embodiments explained in the above description. The following modifications may be included in the technical scope of the present invention, for example. In the following modifications, the same parts as the above embodiment are indicated by the same symbols and will not be explained.

[First Modification]

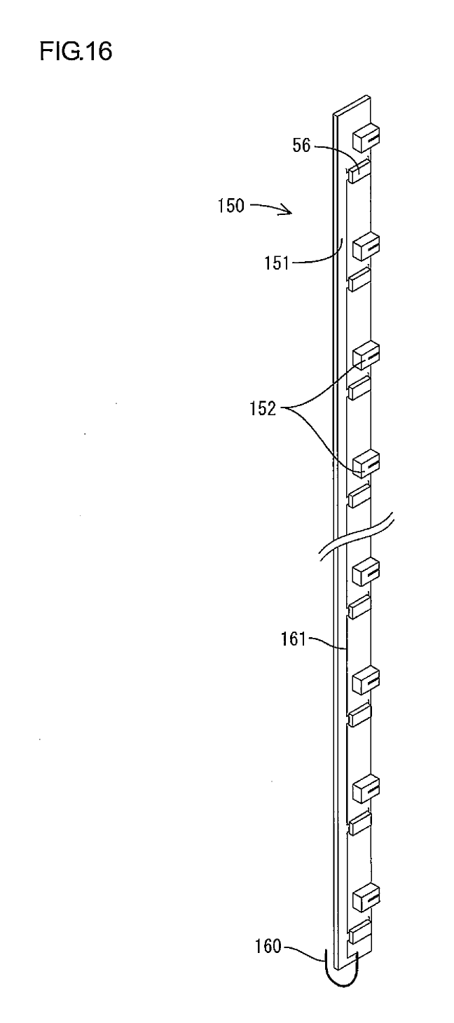

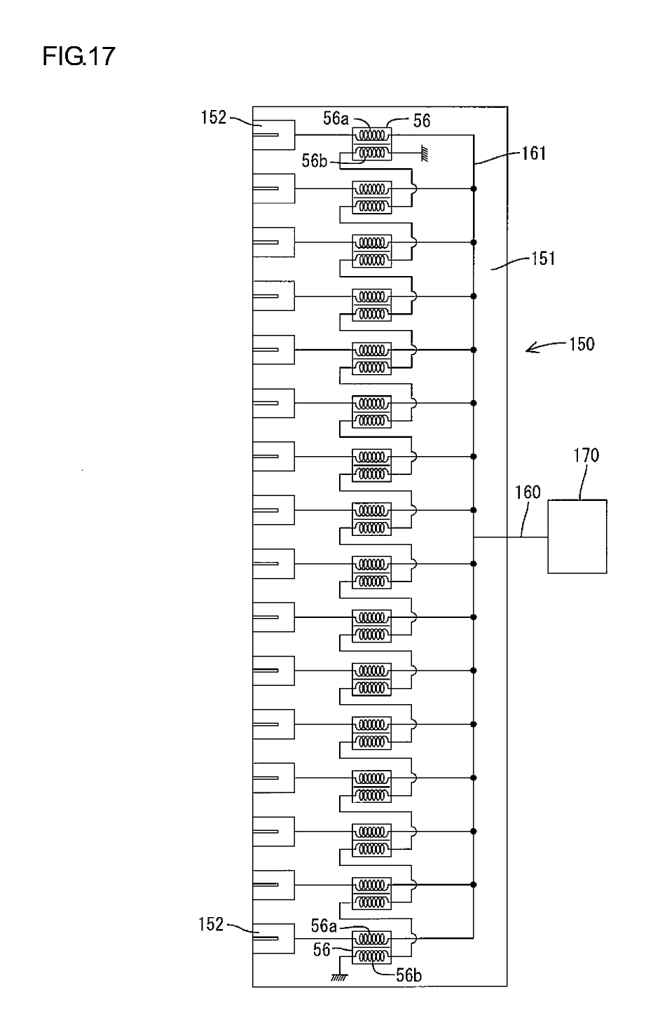

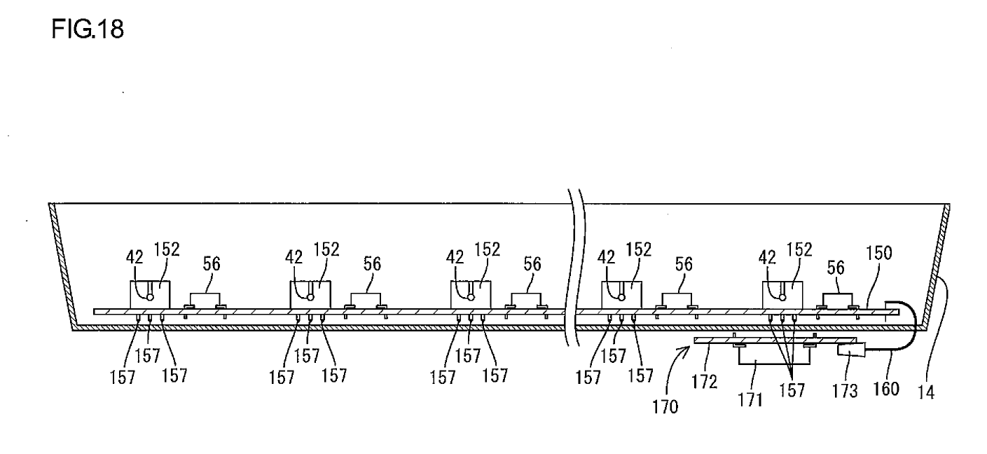

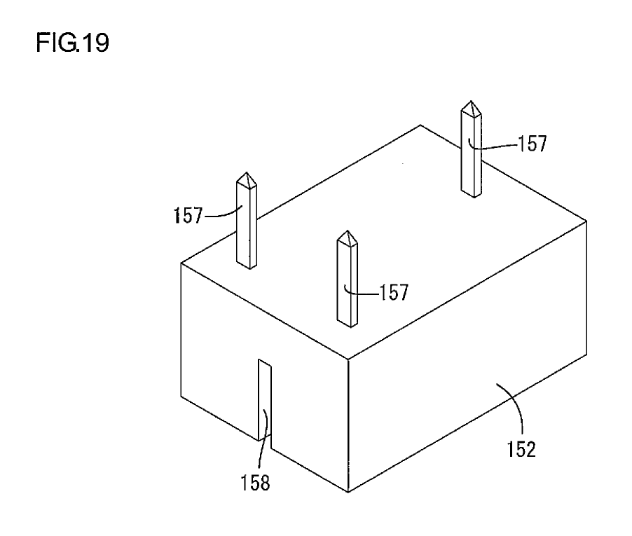

A modification of the relay member 150 is illustrated in FIGS. 16 to 19. FIG. 16 is a perspective view illustrating a construction of the relay member 150 according to the first modification. FIG. 17 is an explanatory view illustrating a circuit configuration of the relay member 150. FIG. 18 is an explanatory view typically illustrating a construction for power supply. FIG. 19 is a perspective view illustrating a construction of the relay body 152 applied to the relay member 150 of the first modification.

The relay member 150 illustrated in FIG. 16 includes the balance coils 56 instead of the capacitor as the balancing components. Each balance coil 56 includes a primary coil 56a and a secondary coil 56b as illustrated in FIG. 17. In the first modification, one balance coil 56 is provided for each relay body 152 and integrally arranged with the relay body 152 on the base 151 formed of an insulated substrate made of glass-epoxy resin, paper phenol or the like.

The relay body 152 has the void 158 and is formed in a cube made of conductive rubber like the above embodiment. In the first modification, as illustrated in FIG. 19, three legs 157 are integrally formed on a surface of the relay body 152 facing the base 151 that is an opposite side from the void 158. The legs 157 are penetrated through mounting holes (not shown) in the base 151 and fixed to the base 151 with soldering or the like. The relay body 152 is electrically connected to the primary coil 56a of the balance coil 56 with being placed on the base 151.

The balance coils 56 are connected to the power supply board (power source) 170 in parallel, and the balance coils 56 are connected to the conductive layer (common line) 161 in parallel here. Electrical connection with the power supply board (power source) 170 is collectively made through the harness 160 derived from the conductive layer 161. The primary coils 56a are connected to the respective relay bodies 152 and the secondary coils 56b are connected with each other in series.

The balance coils 56 and the power supply board 170 are connected via lines that are less than the cold cathode tubes 17, specifically, connected via one harness (power supply path) 160. For example, the harness 160 is routed from an edge of the base 151 disposed on the inner surface (inner surface side) of the chassis 14 to the power supply board 170 disposed on the outer surface (outer surface side), as illustrated in FIG. 18.

Since the balance coils (balancing components) 56 are connected between the relay bodies 152 made of conductive rubber and the power supply board 170 to output the constant current for the driving power supplied to each relay body 152, the current supplied to each cold cathode tube 17 is constant. The balance coils 56 are used as balancing components. Therefore, the driving voltage is reduced and the lighting device is very preferable for the liquid crystal display device 10 included in the television receiver TV, which is a large-screen TV.

Further, the amount of current supplied to each cold cathode tube 17 is kept at a constant level by using the balance coils 56. Therefore, the cold cathode tubes 17 are connected to a single power source 170 in parallel. As a result, a plurality of relay bodies 152 and the balance coils 56 connected to the relay bodies 152 are provided integrally on the base 151, and electrical connection between the base 151 and the power supply board 170 is made with a single line. This simple configuration that is connection with a single line allows the configuration for driving the cold cathode tubes 17 simple and significantly reduces the cost. Further, since the relay body 152 having the void 158 is formed of conductive rubber, the outer lead 42 of the cold cathode tube 17 can be held safely without being damaged and reliable conductivity can be ensured.

[Second Modification]

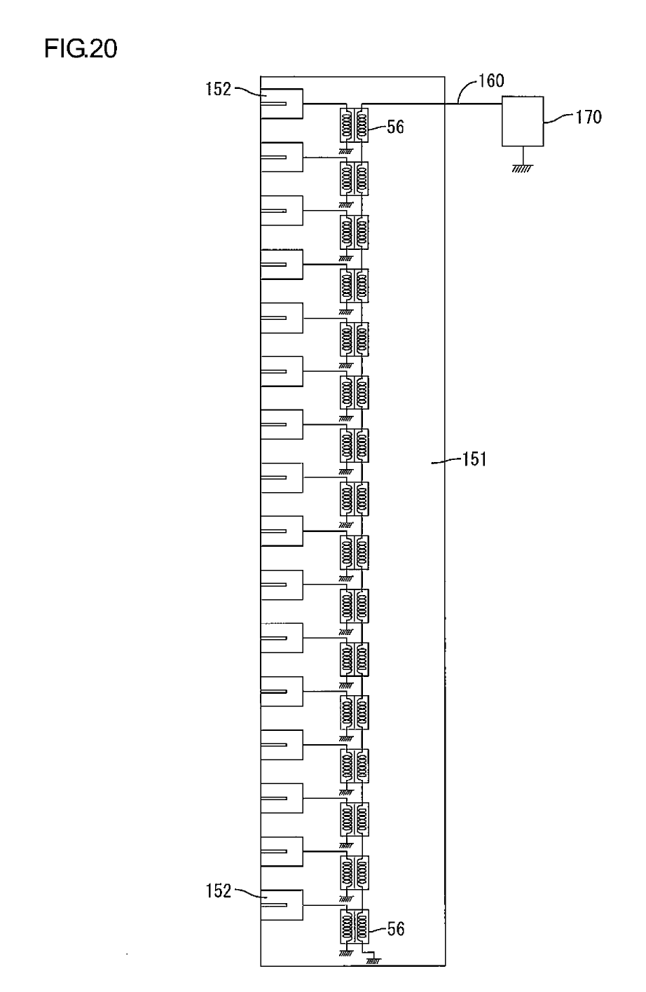

The power supply board 170, the balance coils 56 and the relay bodies 152 can be connected as illustrated in FIG. 20. The relay bodies 152 are connected to the secondary sides of the balance coils 56. The balance coils 56 are arranged such that the primary sides of the balance coils 56 are connected in series. This configuration also makes the amount of current supplied to each relay body 152 (i.e., each cold cathode tube 17) constant. It also allows the connection between the power supply board 170 and the base 151 that collectively includes the relay bodies 152 and the balance coils 56 with a single line (harness) 160. Like the above embodiment, since each relay body 152 having the void 158 for holding the outer lead 42 of the cold cathode tube 17 is formed of conductive rubber, the outer lead 42 of the cold cathode tube 17 can be held safely without being damaged and this ensures reliable electrical conductivity.

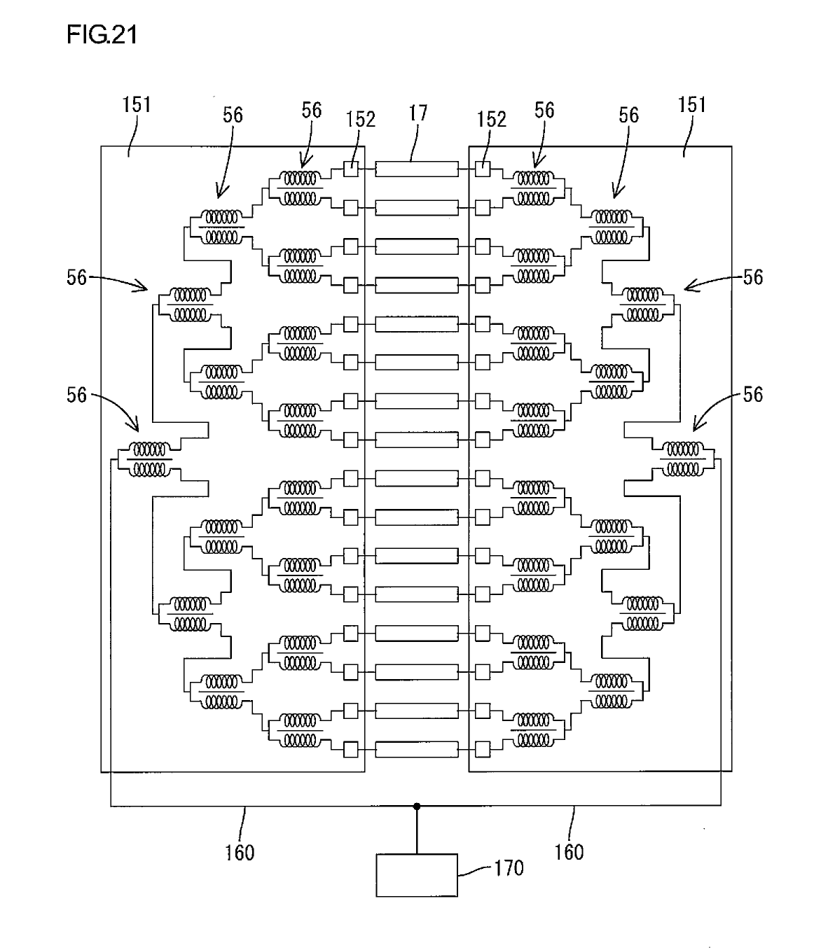

The balance coils 56 may be arranged in a tree structure as illustrated in FIG. 21. In FIG. 21, sixteen cold cathode tubes 17 are provided and fifteen balance coils 56 are disposed on one side each. This configuration also makes the amount of current supplied to each relay body 152 (i.e., each cold cathode tube 17) constant. It also allows the connection between the power supply board 170 and the base 151 that collectively includes the relay bodies 152 and the balance coils 56 with a single line 160 (branched into two ends of the cold cathode tubes 17 in FIG. 21).

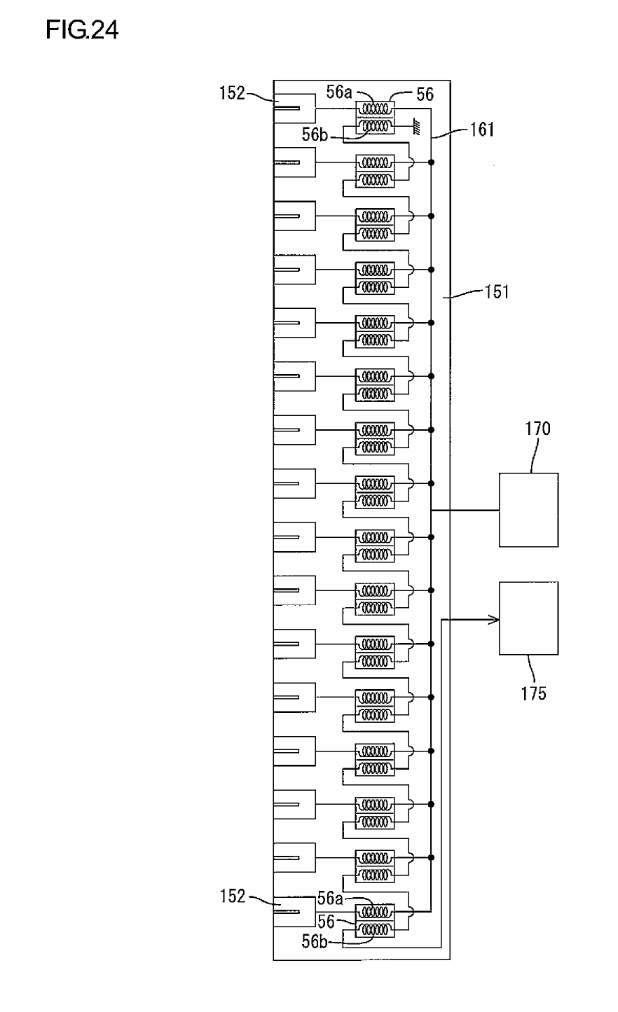

A detection circuit 175 illustrated in FIG. 24 may be provided as an open circuit detection circuit. The detection circuit 175 includes a fail-safe circuit that disable the operation when an unlit cold cathode tube 17 is detected, that is, the circuit is open. It sends feedback indicating an output current of the balance coil 56b on the secondary side. In FIG. 24, the detection circuit 175 detects a current drawn out from a loop circuit on the secondary side of the balance coils 56 off the base 151. The detected current is fed back to the power supply board 170 and if an input voltage continues to rise in a condition that the detected current is very small, an open circuit is determined. Then, the supply of the driving power is stopped. In this embodiment, the balance coils 56 are used as balancing components. If capacitors are used as the balancing components, the open circuit detection is required for each capacitor and thus comprehensive detection of an open circuit is difficult to carry out. Therefore, the open circuit detection circuit using the balance coils 56 as in this embodiment is especially effective and a low-cost and safe configuration can be provided.

[Third Modification]

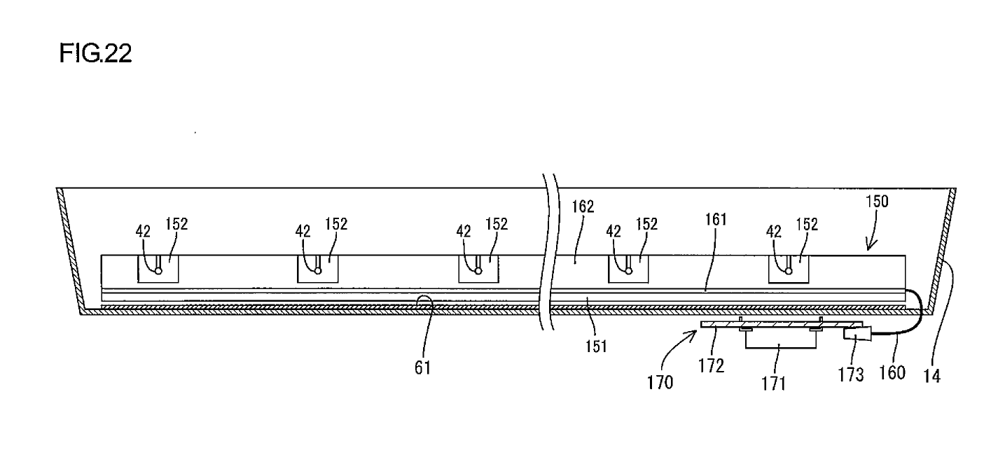

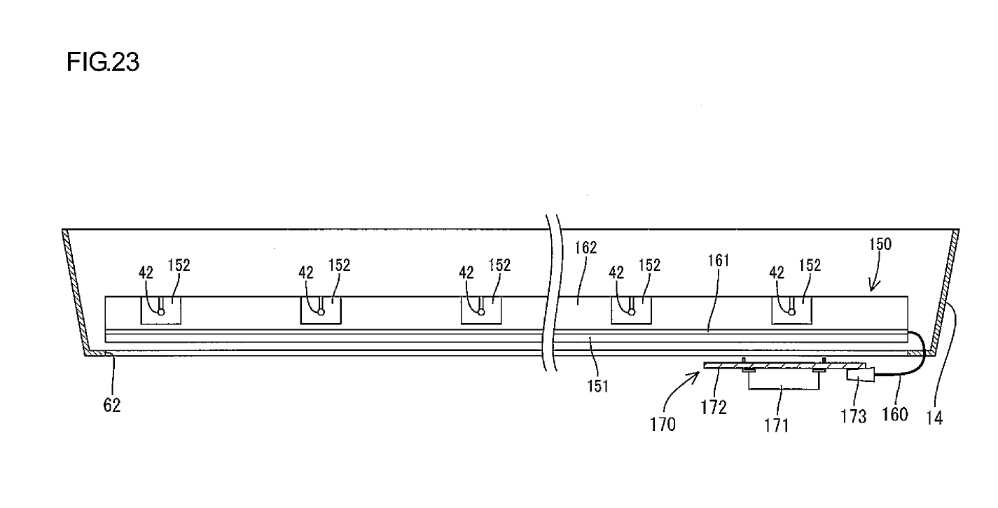

To obtain insulation between the chassis 14 and the base 151, an insulation plate (insulation member) 61 may be provided between the chassis 14 and the base 151 as illustrated in FIG. 22. As illustrated in FIG. 23, an opening 62 may be provided in an area of the chassis 14 that overlaps with the base 151. Alternatively, the chassis 14 may be made of a resin material.

[Fourth Modification]

The power supply board 170 may be arranged as follows.

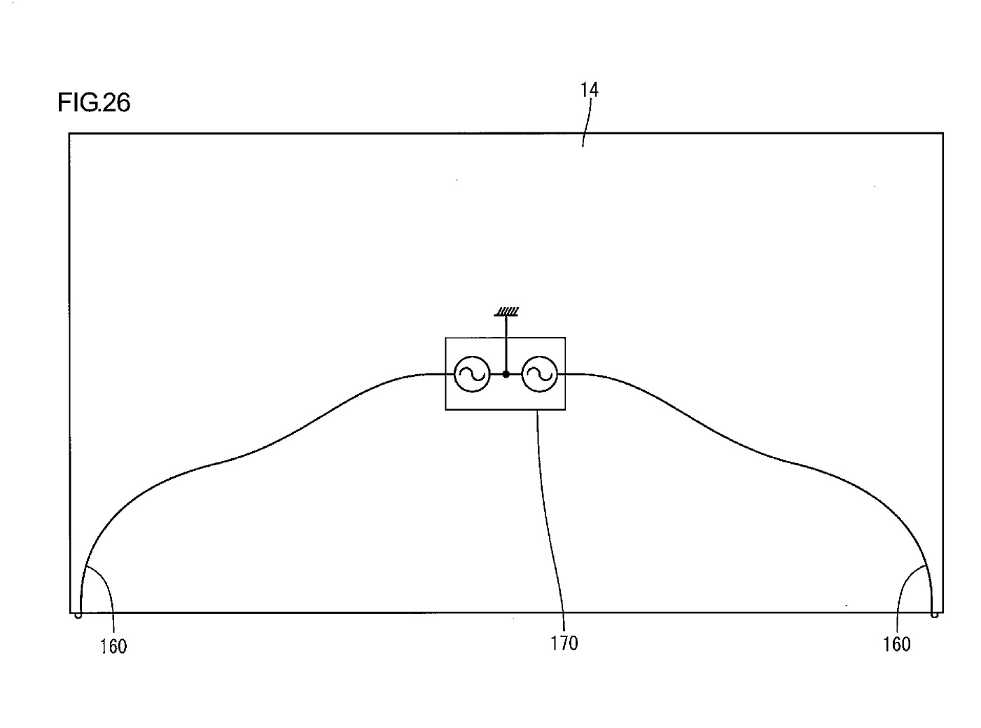

The power supply board 170 in FIG. 26 is arranged in the central area of the rear surface of the chassis 14. As in the above embodiment, only a single power supply line (harness) 160 is required to supply power using the balance coils 56. Therefore, a leak current is easily controlled and thus the power supply board 170 can be arranged in the central area of the chassis 14. As a result, the liquid crystal display device 10 using the backlight device 12 can be made even thinner and this adds higher values to it.

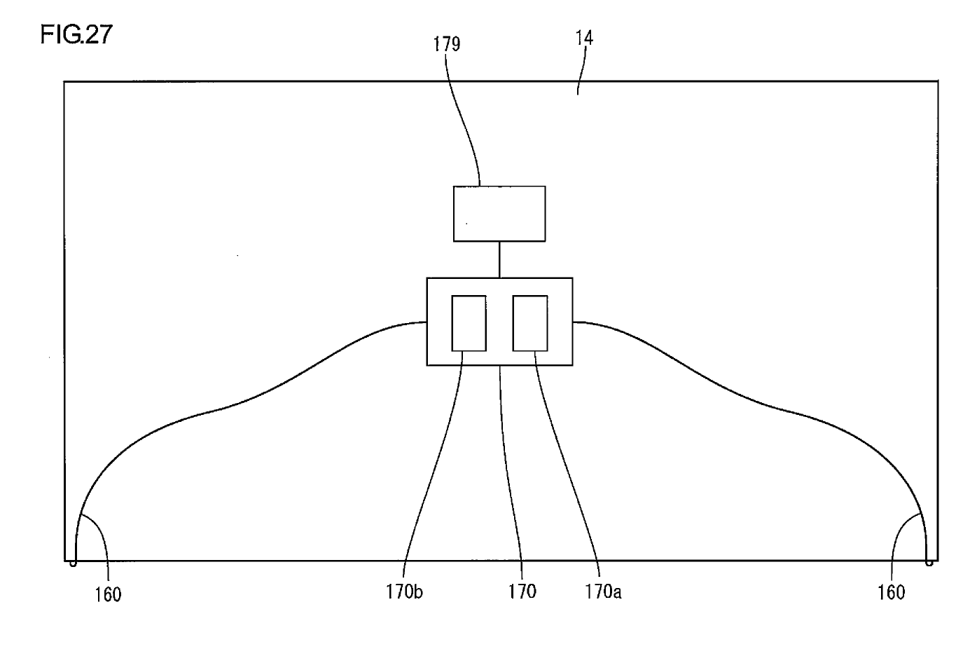

As illustrated in FIG. 27, the power supply board 170 may include a light source driving circuit 170a for driving the cold cathode tubes 17 and a panel driving circuit 170b for driving the liquid crystal panel 11. With this configuration, a primary power is collectively supplied to the power supply board 170 by an AC power source 179. As in the above embodiment, only a single power supply line (harness) 160 is required to supply power using the balance coils 56. Therefore, a light source driving circuit 170a for driving the cold cathode tubes 17 and a panel driving circuit 170b for driving the liquid crystal panel 11 can be provided on the same power supply board 170. With this configuration, a primary power is collectively supplied to the power supply board 170 by an AC power source 179.

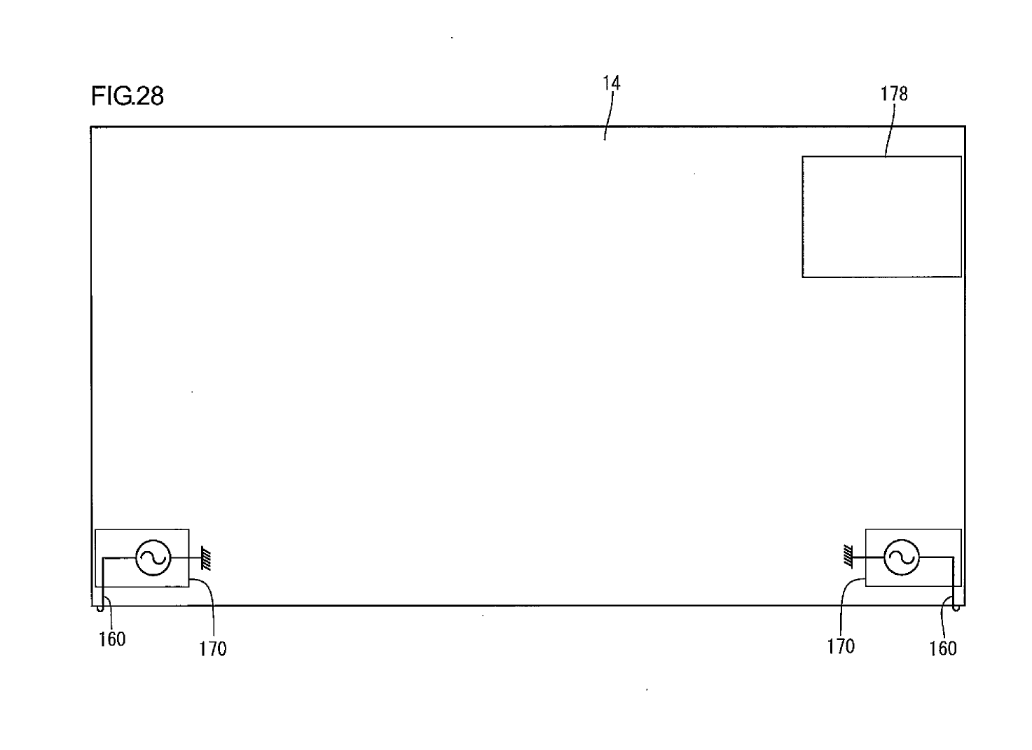

As illustrated in FIG. 28, external information input and output means 178 such as a disk drive may be arranged in an empty space of the chassis 14 in which the power supply boards 170 are arranged. To supply power using the balance coils 56, only a single power supply line (harness) 160 is required and thus the power supply board 170 can be reduced in size. Therefore, the power supply board 170 can be arranged in one area of the chassis along one side (short side) and the external information input and output means 178 such as a disk drive can be arranged in another area. Namely, the space is effectively used.

[Fifth Modification]

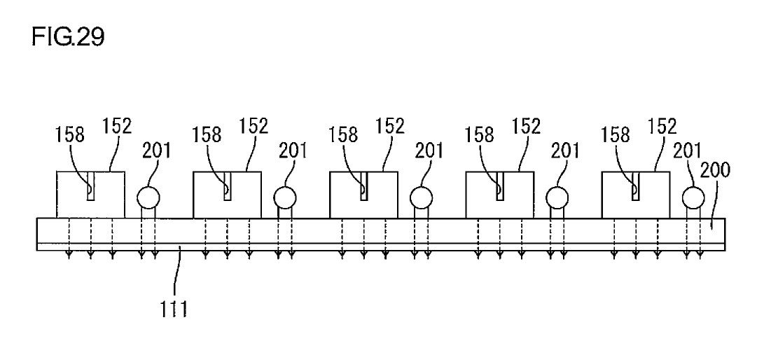

Chip capacitors may be used for the capacitors 56 described in the above embodiment to form the balancing components. As illustrated in FIG. 29, the capacitive coupling between the relay bodies 152 and a common electrode (conductive portion) 111 can be achieved by mounting chip capacitors 201 on a circuit board (paper phenol substrate) 200. In this case, as illustrated in FIG. 29, the relay bodies 152 having the voids 158 and formed of conductive rubber are mounted on the circuit board 200, and the common electrode 111 is electrically connected to each relay body 152 via the corresponding chip capacitor 201. Namely, the chip capacitors 201 are mounted on the circuit board 200 for the respective relay bodies 152.

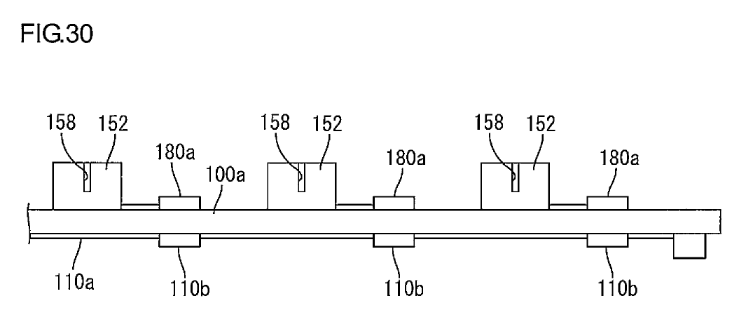

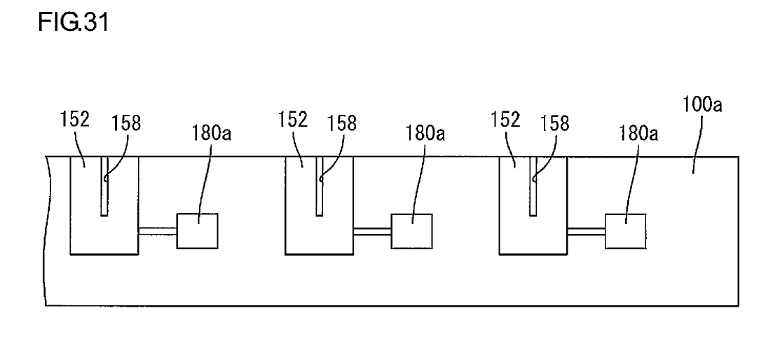

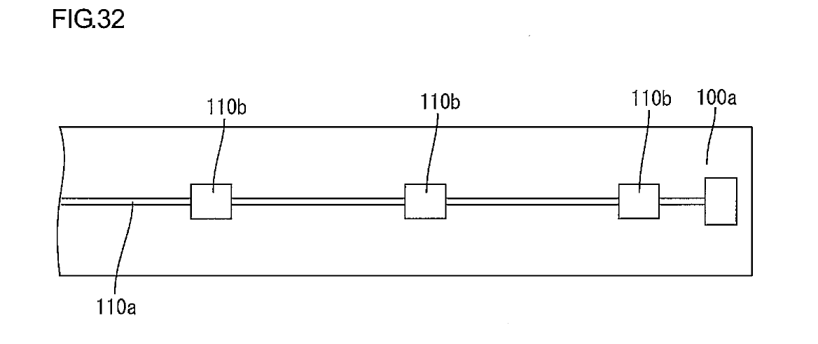

As illustrated in FIG. 30, the electrical connection between each relay body 152 having the void 158 and formed of conductive rubber and the common electrode 110a can be formed by use of a circuit board (a glass-epoxy substrate) 100a as a dielectric portion. In this case, the relay bodies 152 and first-capacity electrodes 180a equipotential to the respective relay bodies 152 are formed on an upper surface (a first surface) of the circuit board 100a, as shown also in FIG. 31. Second-capacity electrodes 110b arranged on the opposite side of the circuit board 100a from the first-capacity electrodes 180a, and the common electrode (a common wiring line) 110a equipotential to the second-capacity electrodes 110b are also formed on a lower surface (a second surface) of the circuit board 100a, as illustrated in FIG. 32. On the rear surface of the circuit board, the common electrode 110a is electrically connected to the terminal of the power supply board 170.

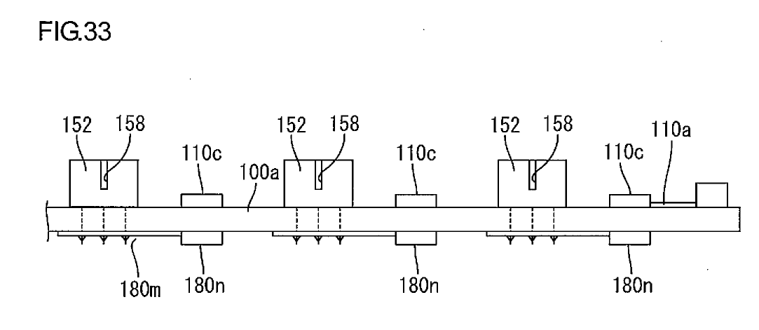

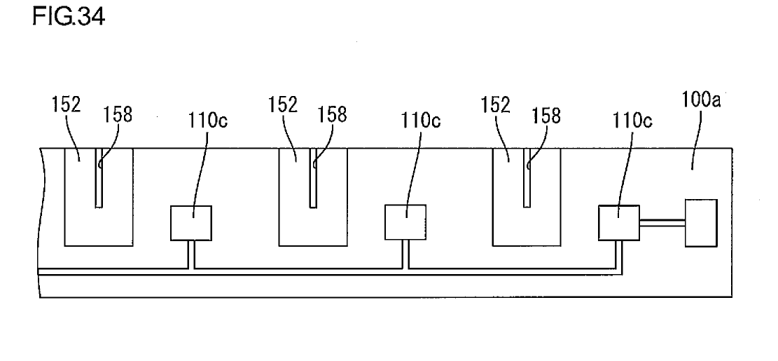

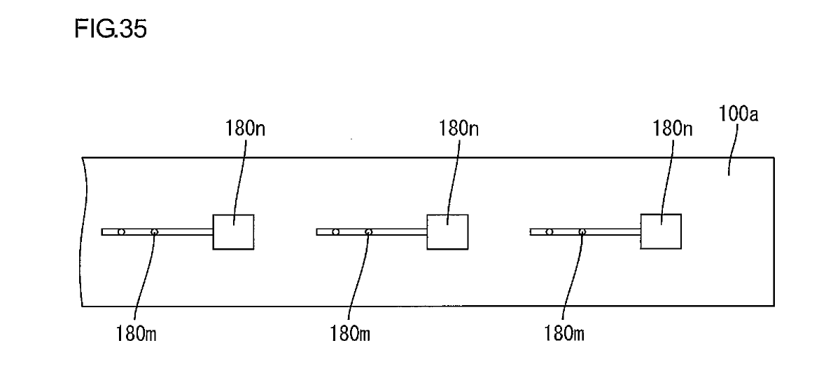

As shown in FIG. 33, the electrical connection between each relay body 152 having the void 158 and formed of conductive rubber and the common electrode 110a can be formed by use of a circuit board (a glass-epoxy substrate) 100a as a dielectric portion. In this case, the relay bodies 152, third-capacity electrodes 110c disconnected from the relay bodies 152, and the common electrode (a common wiring line) 110a equipotential to the third-capacity electrodes 110c are formed on an upper surface (a first surface) of the circuit board 100a, as illustrated in FIG. 34. On the rear surface of the circuit board 100a, the common electrode 110a is electrically connected to the terminal of the power supply board 170. On the other hand, the lead wires (connecting terminal portions) 180m of the relay bodies 152 penetrating the circuit board 100a from the upper surface side, and fourth-capacity electrodes 180n connected to the lead wires 180m so as to be equipotential to the holder 180 are formed on a lower surface (a second surface) of the circuit board 100a, as illustrated in FIG. 35. Thus, the parallel coupling can be readily achieved by forming a wiring pattern on the circuit board 100a so that the capacitors are provided.

[Other Modification]

The display panel 11 of the liquid crystal display device 10 may include switching components other than TFTs. For example, MIMs (Metal Insulator Metal) or other types of switching components can be used. The display device of the present invention is not limited to the liquid crystal display device and various kinds of display device including lighting devices provided behind display panels can be used.

1. A lighting device comprising:
at least one light source;
a power source configured to supply driving power to the light source; and
a relay member configured to electrically connect the light source and the power source, wherein:
the light source includes an outer lead for receiving the driving power supplied by the power source;
the relay member includes at least one relay body having a void in which the outer lead is inserted, the relay body being formed of conductive rubber; and
the outer lead is placed in the void of the relay body with elastic contact thereof and an inner surface of the void.

2. The lighting device according to claim 1, wherein:
the light source includes a glass tube with an end thereof being closed; and
the outer lead projects from the end.

3. The lighting device according to claim 1, wherein the void has a width smaller than an outer diameter of the outer lead in a free state without the outer lead being placed.

4. The lighting device according to claim 1, wherein:
the at least one light source includes a plurality of light sources;
the at least one relay body includes a plurality of relay bodies provided for the light sources, respectively;
the relay member includes balancing components for controlling a current amount of the driving power supplied to relay bodies, the balancing components being provided between the relay bodies and the power source.

5. The lighting device according to claim 4, wherein:
the relay bodies are disposed on a base; and
the balancing components are disposed on the base between the relay bodies and the power source.

6. The lighting device according to claim 5, wherein each of the balancing components includes a conductive portion and a dielectric portion, the conductive portion being disposed on the base and electrically connected to the power source and the dielectric portion being provided between the conductive portion and the relay body.

7. The lighting device according to claim 6, wherein:
the dielectric portion is an insulation layer provided between the conductive portion and the relay bodies; and
the relay bodies are embedded in the insulation layer.

8. The lighting device according to claim 4, wherein the balancing components are balance coils.

9. The lighting device according to claim 8, wherein:
the balance coils include primary coils and secondary coils, respectively; and
the primary coils are connected to the relay bodies and the secondary coils are connected with each other in series.

10. The lighting device according to claim 4, wherein the balancing components are chip capacitors.

11. The lighting device according to claim 4, wherein:
the balancing components are provided for the respective relay bodies; and
the balancing components are connected to the power source in parallel.

12. The lighting device according to claim 4, wherein a number of power supply paths connecting the balancing components and the power source is smaller than a number of the light sources.

13. The lighting device according to claim 4, wherein the balancing components are connected to the power source via a single power supply path.

14. The lighting device according to claim 12, further comprising a chassis housing the light sources, wherein:
the light sources and the relay member are provided inside the chassis;
the power source is provided outside the chassis; and
the power supply path is routed from the relay member provided inside the chassis to the power source provided outside the chassis.

15. The lighting device according to claim 14, wherein an insulator is provided between the chassis and the relay member.

16. The lighting device according to claim 14, wherein the chassis has an opening corresponding to the relay member.

17. A display device comprising:
a lighting device according to claim 1; and
a display panel configured to display using light from the lighting device.

18. The display device according to claim 17, wherein the display panel is a liquid crystal panel using liquid crystal.

19. A television receiver comprising a display device according to claim 17.
